(19) United States
(12) Patent Application Publication
(10) Pub. No.: US 2008/0004188 A1
(43) Pub. Date: Jan. 3, 2008

(54) Method of thickening salt-containing media by adding methacrylate derivatives

(76) Inventors: Jurgen Heidlas, Trostberg (DE); Johann Plank, Trostberg (DE); Gregor Keilhofer, Tacherting (DE); Peter Lange, Obing (DE); Andrea Fenchl, Wasserburg (DE); John Wey, Piscataway, NJ (US)

Correspondence Address: FULBRIGHT & JAWORSKI, LLP, 666 FIFTH AVE, NEW YORK, NY, 10103-3198, US

(21) Appl. No.: 11/706,873

(22) Filed: Feb. 15, 2007

(30) Foreign Application Priority Data
Jun. 28, 2006 (DE) 10 2006 029 752.0

(51) Int. Cl. C09K 8/12

(52) U.S. Cl. 507/119

(57) ABSTRACT

Methacrylate derivatives are added to salt-containing media to thicken the media, and are particularly useful in the exploration of mineral oil or natural gas deposits. The salt-containing media have a specific density of 1.2 to 2.5 kg/l. The respective methacrylate derivatives, which may be, e.g., mono- and/or difunctional variants, have been found to be particularly suitable, are used in a volume ratio of 100 to 1:1 and an amount of 0.5 to 15% by volume. The thickening of the salt-containing media is effected primarily as gel formation, which can be carried out with the aid of free radical initiators and at elevated temperatures. In particular, completion brines, drilling and drill-in fluids and fracturing fluids and acids having high salt contents are to be regarded as aqueous media. The methacrylate derivatives have a markedly good solubility in heavy brines, as are used primarily in upstream processes of the oil industry. They can also be polymerized subterraneously, and they simultaneously have a high thermal stability.

### BACKGROUND AND SUMMARY OF THE INVENTION

The present invention relates to the use of hydroxy- and polyether-functionalized methacrylate derivatives for thickening salt-containing media in the exploration of mineral oil and/or natural gas deposits.

Thickened salt-containing media and crosslinked gels thereof are used in many process steps in the upstream sector of the oil industry, such as, in particular, in the exploration of mineral oil and natural gas. The process engineering background may be very versatile, such as, for example, filtrate control in order to avoid loss of the medium into the ground formation, or to use the medium specifically to build up a pressure in the formation in order to “break it open” in the hydraulic fracturing and hence to improve the productivity thereof with regard to the extraction of the mineral wealth. In the last-mentioned application, sand particles (so-called proppants) which are kept in suspension by means of the viscosity thereof and are subsequently incorporated into the broken-open formation cracks and fissures in order to avoid closing of the openings are often also added to the thickened medium. Owing to their higher density, brines are often used in order, inter alia, to compensate the excess pressure from the drilled ground formation in the well, i.e. in order better to be able to control the drilling.

A certain challenge is the thickening and in particular the gel formation in brines having a high degree of salt saturation, such as the solutions of calcium chloride, calcium bromide or zinc bromide, mixtures thereof with one another or caesium formate, which are frequently used in oil and gas field exploration. These so-called “heavy brines” are defined here with specific density between 1.20 and 2.50 kg per litre, which corresponds to 10.0 to 20.7 ppg as stated in US pounds per gallon (ppg) specific to the industry. The problem of bringing hydrophilic substances into solution in these brines or hydrating said substances—as is generally the case with thickening polymers—is evident in particular as follows: a major part of the water and, in the case of saturated brines, virtually all of the “free” water is bound in the hydrate shell of the salt ions; hence scarcely any water or no water then is available for an additional dissolution or hydration process. In addition, in particular zinc bromide brines show extremely acidic pH values; many polymeric molecules suitable in principle for thickening are cleaved at these pH values, which makes them unsuitable for this special case. This is also true in particular under the conditions of elevated temperatures as are encountered with increasing depth (drilling depth).

In order to obtain a sufficient viscosity, water-soluble polymers are often used, the hydrated polymer subsequently being crosslinked. Often, polysaccharides and derivatives thereof are used, such as guar, guar derivatives or hydroxyethylcellulose, which are referred to as “biopolymers” in the case of a natural origin. The crosslinking can be achieved, inter alia, via ester formation of the polyhydroxy molecules, such as, for example, via the formation of borates, titanates or zirconates (U.S. Pat. No. 3,888,312, U.S. Pat. No. 4,462,917, U.S. Pat. No. 4,579,670). This procedure is excellent for the preparation of gels if the brines have a lower density, as is the case of sodium chloride or potassium chloride solutions; experience has shown, however, that this is practically not applicable in the case of many heavy brines, in particular the zinc bromide-containing variants.

A further possibility for the preparation of stable gels is the use of graft polymers of hydroxyalkylcellulose, guar or hydroxypropylguar, onto which a vinylphosphonic acid has been “grafted”. In this case, crosslinking is effected in the presence of bivalent cations via the addition of Lewis bases or Broensted-Lowry bases (U.S. Pat. No. 5,304,620). However, said graft polymers have the economic disadvantage of being very expensive. Furthermore, the practical use of this procedure is not without problems since the polymers can be scarcely hydrated or hydrated only in a very time-consuming manner in almost unsaturated or saturated brines.

In order to overcome this solubility problem of polymeric compounds in brines, less complex molecules, such as surfactants, were also used as so-called viscoelastic surfactant systems (VES) for thickening brines. Although high-viscosity crosslinked gels cannot be prepared with VES their unproblematic solubility in heavy brines often permits in practice concessions with regard to the viscosity achieved. VES are in fact capable of forming “rod-shaped” or “worm-shaped” micelles and thus thickening the solution. There are numerous publications which are concerned with the use of VES in the oilfield sector. U.S. Pat. No. 4,965,389, US 2002/0033260, US 2003/0236174, U.S. Pat. No. 6,762,154, WO 98/56 497 A1, U.S. Pat. No. 5,964,295 and U.S. Pat. No. 6,509,301 maybe mentioned by way of example in this context.

The VES systems originally regarded as being particularly suitable have also proved useful in the thickening of water-based drilling fluids and in particular of brines and fracturing fluids, but likewise only to a limited extent. As a rule, a high surfactant concentration is in fact necessary in order to achieve a sufficient thickening. High-viscosity gels based on crosslinked polymers can scarcely be prepared with VES. Moreover, the solutions thickened with VES generally have only very little thermal stability and the viscosity collapses because the surfactants separate from the water phase. In addition, particularly for the so-called brines very special surfactant formulations are required. That is because such formulations can be used only for very special systems, i.e. depending on the salt used, and in an extremely narrow range of the tolerated salt concentrations. In summary, it may be stated that many different products and systems are necessary in order to meet the requirements in practice. This of course is also to be regarded as being very disadvantageous from economic points of view.

The idea of pumping reactive components into the well and causing them to react subterraneously by means of crosslinking for stabilizing the well during the drilling process is described in U.S. Pat. No. 6,702,044. Water-soluble or water-dispersible polymers are used together with a polymeric cationic catalyst; these harden during the crosslinking and thus consolidate the unstable formation. Owing to the solubility problems, however, this procedure cannot be used for the preparation of high-viscosity gels in heavy brines.

In order to suppress the inflow of water into oil and gas reservoirs (water shut-off) U.S. Pat. No. 6,843,841 proposes the pumping of a water-soluble and polyacrylate based polymer, together with a non-toxic and chitosan based crosslinking agent into the ground formation and gelling it there after a time lag by crosslinking. As pointed out several times above, however, this procedure too cannot be used for heavy brines owing to the limited solubility/hydration of the polymers.

In principle, even with the use of non-polymeric, i.e. monomeric, compounds for the preparation of high-viscosity gels in heavy brines, solubility problems are the rule and many different variants are therefore not suitable because they are either insoluble or non-dispersible in the highly saline systems. With the use of reactive compounds, such as reactive monomers, it is necessary additionally to fulfill aspects of health protection and environmental protection in order to provide an economically relevant alternative.

Based on the described disadvantages of the state of the art, it was the object of the present invention to develop a chemical system and a corresponding procedure for the formation of high-viscosity gels in heavy brines, by means that as far as possible eliminate in particular the disadvantages in the upstream sector of the oil industry, i.e. in the exploration of the mineral oil or natural gas deposit.

This object was achieved by the use of hydroxy- and polyether-functionalized methacrylate derivatives for thickening salt-containing media in the exploration of mineral oil and/or natural gas deposits, the salt-containing media having a specific density of 1.2 to 2.5 kg/l.

### DETAILED DESCRIPTION

Surprisingly, it was found that hydroxy- and polyether (PE)-functionalized methacrylate derivatives not only have a very large solubility in the heavy brines that usually are used in the upstream sector of the oil industry, such as, in particular, calcium chloride, calcium bromide or zinc bromide and mixtures thereof, and under conditions of a specific density between 1.20 and 2.50 kg per litre. They also can be polymerized subterraneously. It was not foreseeable that the resulting high molecular weight polymers would not be precipitated from the brine and that homogeneous high-viscosity crosslinked gels which have high thermal stability would form. Moreover, depending on the choice of the crosslinking difunctional methacrylate derivatives and in particular on the length of the polyethylene glycol chains between the two methacrylate functions the gel structure can be broken by of commercial oxidizing agents. These so-called breakers are often encapsulated for retardation. As a result the removal of the brine in a desired process from the well to be explored, for example by pumping away, is facilitated.

Mono- and/or difunctional variants have proved to be particularly suitable methacrylate derivatives. According to the invention, in particular hydroxyethyl methacrylate (HEMA) and hydroxypropyl methacrylate (HPMA) and polyethers (PE) derivatives thereof, preferably end group-protected polyethylene glycol (PEG) derivatives thereof, such as MPEG-200 methacrylate (methacrylate=MA), MPEG-400 MA or MPEG-750 MA, are suitable as monofunctional methacrylate derivatives. For economic reasons the use of HEMA is preferred and, inter alia, in certain cases the longer-chain PE derivatives or nitrogen-containing methacrylate derivatives may be necessary for keeping the resulting polymer in solution. By using PE derivatives, in particular the longer-chain variants, the polymer and hence the gel structure can be readily oxidatively degraded, which is desirable in the process for certain fields of use.

Suitable difunctional methacrylate derivatives (DMA) are in particular such compounds in which the two methacrylate groups are linked via a PE group, such as, in particular, ethylene glycol groups: ethylene glycol-DMA, di-, tri- and tetraethylene glycol-DMA and the longer-chain PEG derivates, PEG-200-DMA, PEG-400-DMA or PEG-600-DMA. Derivatives having longer PEG groups will in particular be chosen if a breaking of the gel structure with oxidizing agents is intended.

Depending on the desired viscosity and structure of the gel, a certain concentration and a certain ratio of mono- and difunctional methacrylates should be chosen, which, however, may vary within wide ranges. The present invention envisages a preferred concentration between 1 and 10% by volume, concentrations between 2 and 6% by volume being particularly suitable. The ratio of mono-functional to difunctional methacrylate derivatives in the salt-containing medium should be 100 to 1:1 and preferably 50 to 5:1.

A feature according to the invention is to be seen in the specific density of the salt-containing media. In preferred cases, they should be between 1.4 and 2.3 kg/l and preferably between 1.7 and 2.3 kg/l.

The present invention likewise envisages adding the methacrylate derivatives to the salt-containing medium in an amount of 0.5 to 15% by volume and preferably in amounts between 1.0 and 10% by volume.

Not least, in order to impart an affinity for certain surfaces (metallic or mineral) to the crosslinked polymers or—as already mentioned above—to protect the resulting polymer from precipitation from the brine, it is also possible, in addition to the mono functional hydroxy- and/or polyether-functionalized methacryl ate derivatives, to add other methacrylate derivatives which are not hydroxy- and/or polyether-functionalized. Methacrylic acid, C₁-C₁₀-alkyl-substituted and/or nitrogen-containing methacrylate derivatives, such as 3-trimethylaminopropyl methacrylamide chloride (MAPTAC), 3-dimethylaminopropyl methacrylamide (DMAPMA), 2-trimethylaminoethyl methacrylate chloride (TMAEMC), 2-dimethylaminoethyl methacryl ate (DMAEMA) or N-(2-methacryloyloxyethyl)ethyleneurea (MEEU) are particularly suitable for this purpose. In order to avoid suppressing gel formation too greatly, the amount according to the invention of these other methacrylate derivatives should be not more than 40% by weight and preferably 5 to 25% by weight, based in each case on the sum of the hydroxy- and polyether-functionalized methacrylate derivatives.

The urea derivative N-(2-methacryloyloxyethyl)ethyleneurea (MEEU), commercial product of Degussa GmbH: Mhromer 6852-O and 6844-O), which likewise has a markedly good solubility in the heavy brines described, is suitable as a nitrogen-containing methacrylate derivative which can act as a crosslinking agent.

The polymerization and hence the thickening are effected according to the invention with the aid of free radical polymerization initiators. In particular, azo compounds, such as 2,2′-azobis(2-aminopropane) dihydrochloride, are suitable. In general, temperature ranges >55° C. are recommended for the thickening, a range between 40 and 100° C. being regarded as particularly suitable. The possibility of temperature-induced initiation of the reaction is of particular interest since the solution can be pumped with low viscosity into the formation and can be thickened to give a high-viscosity liquid or to give a crosslinked gel in the formation itself and at the desired point with simultaneously increased temperature in the well. Optionally, oxidizing agents (breakers) can be suspended in the brine for retarded degradation of the thickened liquid before pumping into the formation, peroxides or hypochlorites being particularly suitable for this purpose.

The potential applications of the use according to the present invention in mineral oil and natural gas exploration are the thickening and gel formation of all aqueous media which contain heavy brines, and in particular of completion brines, drilling and drill-in fluids, fracturing fluids, acids, in particular acids weighted with heavy brines, or stimulation fluids.

Of particular interest is the use in acids which are weighted with brines, in particular zinc bromide, calcium bromide or calcium chloride, preferably in association with acidizing of a carbonate-containing ground formation for improving the productivity.

The following examples illustrate the advantages of the present invention.

### EXAMPLES OF PREFERRED EMBODIMENTS

### Example 1

3.0 g of hydroxyethyl methacrylate (commercial product from Degussa GmbH: Mhoromer BM 903) and 0.6 g of polyethylene glycol-600 dimethacrylate (commercial product from Degussa GmbH: Mhoromer D 1120) as a crosslinking agent were added to 100 ml of zinc bromide/calcium bromide brine having a specific density of 2.06 kg/l (17.2 US pounds per gallon, ppg) and stirred on a magnetic stirrer at ambient temperature until a clear solution had formed. 0.25 g of 2,2′-azobis(2-aminopropane) dihydrochloride (commercial product from Wako Chemicals GmbH: Wako V-50) as initiator was dissolved in 2 ml of tap water and the clear solution was then added to the stirred brine.

The brine containing the components described was then heated with gentle stirring on the magnetic stirrer. The reaction started at a temperature of about 65° C. (140° F.), and a high-viscosity, stable, almost “firm” gel formed.

The gel obtained was placed in a drying oven for 72 hours at 150° C. (300° F.), after which the gel structure was still intact. The thickened brine showed no synthesis.

### Example 2a

3.2 g of hydroxyethyl methacrylate (commercial product from Degussa GmbH: Mhoromer BM 903) and 0.5 g of polyethylene glycol-400 dimethacrylate (commercial product from Degussa GmbH: Mhoromer MFM 409) as a crosslinking agent were added to 100 ml of a saturated calcium chloride brine having a specific density of 1.70 kg/l (14.2 US pounds per gallon, ppg) and stirred on a magnetic stirrer at ambient temperature until a clear solution had formed. 0.25 g of 2,2′-azobis(2-aminopropane) dihydrochloride (commercial product from Wako Chemicals GmbH: Wako V-50) as an initiator was dissolved in 2 ml of tap water and the clear solution was then added to the stirred brine.

After heating according to example 1 to about 65° C. (140° F.), the reaction started and a high-viscosity, stable, almost “firm” gel formed, which was stable for 72 h at 150° C. (300° F.).

### Example 2b

This example shows how the viscosity of the thickened brine can easily be adjusted by reducing the concentration of crosslinking agent.

The experimental batch was identical to example 2a, but the addition of crosslinking agent, polyethylene glycol-400 dimethacrylate (commercial product from Degussa GmbH: Mhoromer MFM 409), was reduced from 0.5 g to 0.05 g. A greatly thickened brine formed, which, however, was no longer a “firm” gel.

### Example 3

5.0 g of hydroxyethyl methacrylate (commercial product from Degussa GmbH: Mhoromer BM 903) and 0.8 g of polyethylene glycol-200 dimethacrylate (commercial product from Degussa GmbH: Mhoromer D 1133) as a crosslinking agent were added to 100 ml of a saturated zinc bromide brine having a specific density of 2.30 kg/l (19.2 US pounds per gallon, ppg) and stirred on a magnetic stirrer at ambient temperature until a clear solution had formed. 0.25 g of 2,2′-azobis(2-aminopropane) dihydrochloride (commercial product from Wako Chemicals GmbH: Wako V-50) as an initiator was dissolved in 2 ml of tap water and the clear solution was then added to the stirred brine.

After heating according to example 1 to about 65° C. (140° F.), the reaction started and a high-viscosity, stable, “firm” gel formed. The thermal stability was comparable with that of examples 1 and 2.

### Example 4a

### Comparison

3.0 g of hydroxyethyl methacrylate (commercial product from Degussa GmbH: Mhoromer BM 903) and 0.8 g of polyethylene glycol-400 dimethacrylate (commercial product from Degussa GmbH: Mhoromer MFM 409) as a crosslinking agent were added to 100 ml of saturated calcium bromide brine having a specific density of 1.39 kg/l (11.6 US pounds per gallon, ppg) and stirred on a magnetic stirrer at ambient temperature. 0.25 g of 2,2′-azobis(2-aminopropane) dihydrochloride (commercial product from Wako Chemicals GmbH: Wako V-50) as an initiator was dissolved in 2 ml of tap water and the clear solution was then added to the stirred brine.

After heating according to example 1 to about 65° C. (140° F.), the reaction started. Instead of forming a gel, the brine became turbid and a white precipitate formed which did not have a thickening or a gel-forming effect. Rather, the resulting polymer was precipitated from the brine.

The following examples show the prevention of the precipitation can be prevented for the purposes of the invention by the addition of PE- or nitrogen-containing methacrylate derivatives.

### Example 4b

1.0 g of hydroxyethyl methacrylate (commercial product from Degussa GmbH: Mhoromer BM 903), 4.0 g of a 50% strength aqueous solution of MPEG-750 methacrylate (commercial product from Degussa GmbH: Rohamere 6850-O) and 0.8 g of polyethylene glycol-600 dimethacrylate (commercial product from Degussa GmbH: Mhoromer D 1120) as a crosslinking agent were added to 100 ml of saturated calcium chloride brine having a specific density of 1.39 kg/l (11.6 US pounds per gallon, ppg) and stirred on a magnetic stirrer at ambient temperature. 0.25 g of 2,2′-azobis(2-aminopropane) dihydrochloride (commercial product from Wako Chemicals GmbH: Wako V-50) as an initiator was dissolved in 2 ml of tap water and the clear solution was then added to the stirred brine.

After heating according to example 1 to about 65° C. (140° F.), the reaction started and, in contrast to example 4a, a high-viscosity, stable, “firm” gel formed which had a milky turbidity. The thermal stability was comparable with that of examples 1 to 3.

### Example 4c

2.5 g of hydroxyethyl methacrylate (commercial product from Degussa GmbH: Mhoromer BM 903), 0.65 g of 2-dimethylaminoethyl methacrylate (DMAEMA, commercial product from Degussa GmbH: Mhoromer BM 601) and 0.5 g of polyethylene glycol-400 dimethacrylate (commercial product from Degussa GmbH: Mhoromer MFM 409) as a crosslinking agent were added to 100 ml of a saturated calcium chloride brine having a specific density of 1.39 kg/l (11.6 US pounds per gallon, ppg) and stirred on a magnetic stirrer at ambient temperature. 0.25 g of 2,2′-azobis(2-aminopropane) dihydrochloride (commercial product from Wako Chemicals GmbH: Wako V-50) as an initiator was dissolved in 2 ml of tap water and the clear solution was then added to the stirred brine.

After heating according to example 1 to about 65° C. (140° F.), the reaction started and, in contrast to comparative example 4a, a high-viscosity, stable, “firm” gel formed which had a milky turbidity. The thermal stability was comparable with that of examples 1 to 3.

1-11. (canceled)

12. A method comprising adding a sufficient amount of a hydroxy- and a polyether-functionalized methacrylate derivative to a salt-containing media having a specific density of 1.2 to 2.5 kg/l to thicken the salt-containing media.

13. The method of claim 12, wherein the hydroxy- and polyether functionalized methacrylate is at least one of a mono- or difunctional methacrylate derivative.

14. The method of claim 13, wherein the monofunctional derivative is selected from the group consisting of hydroxyethyl methacrylate and hydroxypropyl methacrylate, and wherein the polyether functionalized methacrylate is an end group-protected polyethylene glycol (PEG) derivative.

15. The method of claim 14, wherein the polyethylene glycol derivative is selected from the group consisting of MPEG-200 methacrylate, MPEG-400 methacrylate and MPEG-750 methacrylate.

16. The method of claim 13, wherein the difunctional derivative is a compound having two methacrylate groups linked via a polyether group selected from a polyethylene glycol group and a polypropylene glycol group.

17. The method of claim 16, wherein the polyether group is selected from the group consisting of ethylene glycol dimethacrylate, diethylene glycol dimethacrylate, triethylene glycol dimethacrylate, tetraethylene glycol dimethacrylate, PEG-200 dimethacrylate, PEG-400 dimethacrylate and PEG-600 dimethacrylate.

18. The method of claim 13, wherein a volume ratio of monofunctional to the difunctional methacrylate derivatives in the salt-containing medium is 100 to 1:1.

19. The method of claim 12, wherein the salt-containing medium has a specific density between 1.4 and 2.3 kg/l

20. The method of claim 12, wherein the salt-containing medium has a specific density between 1.7 and 2.3 kg/l.

21. The method of the claim 12, wherein the functionalized methacrylate derivative is added to the salt-containing medium in an amount of 0.5 to 15% by volume.

22. The method of claim 12, further comprising adding at least one non-hydroxy-functional or non-polyether-functional methacrylate derivative that is a methacrylic acid, or is an alkyl-substituted or nitrogen-containing methacrylate derivative.

23. The method of claim 22, wherein the non-hydroxy-functional or non-polyether-functional methacrylate derivate is selected from the group consisting of 3-trimethylaminopropyl methacrylamide chloride, 3-dimethylaminopropyl methacrylamide, 2-dimethylaminoethyl methacrylate chloride, 2-dimethylaminoethyl methacrylate and N-(2-methacryloyloxyethyl)ethyleneurea.

24. The method of claim 22, wherein the non-hydroxy-functional or non-polyether-functional methacrylate derivative is added to the salt-containing medium in an amount of not more than 40% by weight, based on the total amount of methiacrylate derivative.

25. A method according to claim 12, wherein the thickening is effected as gel formation which is conducted by adding at least one free radical initiator to the salt-containing media or by elevating the temperature to from 4 to 100° C., or both.

26. The method of claim 12, wherein the salt-containing media is a completion brine, a drilling fluid, a drill-in fluid, a fracturing fluid, a stimulation fluid and an acid.

27. The method according to claim 12, wherein the salt-containing media comprises zinc bromide, calcium bromide or calcium chloride.

28. The method of claim 23, wherein the at least one free radical initiator or an oxidizing agent selected from the group consisting of a peroxide and a hypochlorite are added to the medium before the introduction thereof into the well.

29. The method of claim 18, wherein the volume ratio is 50 to 5:1.

30. The method of claim 21, wherein the methacrylate derivative is added in an amount of from 1.0 to 10% by volume.

31. The method of claim 25, wherein the free radical initiator is 2,2′-azobis(2-aminopropane) dihydrochloride.
